(19) United States
(12) Patent Application Publication
(10) Pub. No.: US 2021/0046727 A1
(43) Pub. Date: Feb. 18, 2021

(54) THIN-PLY CONDUCTIVE HEALTH MONITORING TANK

(71) Applicant: Composite Technology Development, Inc., Lafayette, CO (US)

(72) Inventors: Paul Fabian, Broomfield, CO (US); Joseph Wintergerst, Longmont, CO (US); Mark Haynes, Nederland, CO (US); Alexi Rakow, Lafayette, CO (US)

(21) Appl. No.: 16/991,823

(22) Filed: Aug. 12, 2020

Related U.S. Application Data
(60) Provisional application No. 62/885,816, filed on Aug. 13, 2019.

(51) Int. Cl. B32B 5/02

(52) U.S. Cl. CPC B32B 5/022; B32B 5/024; B32B 2255/02; F17C 2203/0607; B32B 2307/202; F17C 2203/0663; B32B 2262/106

(57) ABSTRACT

Some embodiments include a health monitoring tank. The health monitoring tank may include a plurality of wound fiber layers; a plurality of conductor coated nonwoven fabric layers interleaved with the plurality wound fiber layers; and a resistance measuring circuit coupled with the plurality of nickel coated nonwoven carbon fabric layers.

### BACKGROUND

Health monitoring of hydrogen storage tanks can be valuable to prevent leakage and potential explosive hazards. The safe storage of hydrogen requires safety measures such as the proposed technology to make hydrogen fuel storage reliable and safe. Early warning systems can increase public safety and may also reduce the over-design of COPVs while leading to reduced materials and manufacturing costs.

### SUMMARY

Some embodiments include a tank comprising: a plurality of wound fiber composite layers; a plurality of metal coated nonwoven fabric layers interleaved with the plurality of wound composite layers; and a resistance measuring circuit coupled with the plurality of metal coated nonwoven fabric layers. The plurality of metal coated nonwoven fabric layers and the resistance measuring circuit can be used to monitor or measure the health of the tank.

In some embodiments, the tank includes a plurality of electrodes coupled with a respective one of the plurality of nickel coated nonwoven carbon fabric layers. In some embodiments, the tank includes an epoxy resin disposed with the plurality of wound fiber layers and the plurality of nickel coated nonwoven carbon fabric layers.

Some embodiments include a tank comprising: a plurality of wound fiber layers; a plurality of metal coated nonwoven fabric layers interleaved with the plurality wound fiber layers; and a resistance measuring circuit coupled with the plurality of metal coated nonwoven carbon fabric layers.

In some embodiments, the tank includes a plurality of electrodes coupled with a respective one of the plurality of metal coated nonwoven fabric layers. In some embodiments, the metal comprises nickel. In some embodiments, the nonwoven fabric layers comprise carbon. In some embodiments an epoxy resin disposed with the plurality of wound fiber layers and the plurality of metal coated nonwoven fabric layers.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1A illustrates a roll of conductive nickel coated, nonwoven carbon fabric according to some embodiments.

FIG. 1B is a microscopic image of a conductive nickel coated, nonwoven carbon fabric according to some embodiments.

FIG. 2 is an illustration of a health monitoring tank according to some embodiments.

FIG. 3 is an illustration of a top portion of a health monitoring tank according to some embodiments.

FIG. 4 is a cutaway view of a top portion of a health monitoring tank according to some embodiments.

FIG. 5 is a transparent section view of a health monitoring tank according to some embodiments.

FIG. 6 is an illustration of an aluminum lined SCBA tank according to some embodiments.

FIG. 7A illustrate examples of composite linerless tanks according to some embodiments.

FIG. 7B illustrate examples of SCBA tanks according to some embodiments.

FIG. 8A is an image of microcracking within a fiber reinforced composite.

FIG. 8B is an image of microcracking within a fiber reinforced composite.

FIG. 9A is a diagram of a four probe health monitoring system according to some embodiments.

FIG. 9B is a diagram of a two probe health monitoring system according to some embodiments.

FIG. 10A is a photograph of a composite tank according to some embodiments

FIG. 10B is a photograph of a composite tank on a filament winding machine according to some embodiments.

FIG. 11 is a flowchart of a process for monitoring the health of the tank according to some embodiments.

FIG. 12 shows an illustrative computational system for performing functionality to facilitate implementation of embodiments described in this document.

### DETAILED DESCRIPTION

Some embodiments include a sensor layer that can be used to monitor the health of a filament wound pressure vessel (e.g., a composite overwrapped pressure vessel (COPV)). In some embodiments, the sensor layer may be integrated within or between composite filament layers. In some embodiments, the sensor layer(s) may be thin, conductive, ultra-lightweight, or have uniform in-plane electrical properties. In some embodiments, the sensor layer(s) can include resistance-based electrodes. Resistance, for example, has been demonstrated to be sensitive to matrix cracking, delamination, or various forms of composite laminate failure.

A sensor layer may be included in or integrated with one or more composite overwrap layers in a type III, type IV, or type V tank. The composite overwrap layer, for example, may include one or more carbon fiber layers with an epoxy resin matrix. A type III tank, for example, may include a tank with a metal liner with one or more composite overwrap layers (e.g., an SCBA tank). A type IV tank, for example, may include a tank with a polymer liner and one or more composite overwrap layers. A type V tank, for example, may include an all-composite tank without a liner.

Some embodiments include a tank comprising: a plurality of wound fiber layers; a plurality of metal coated nonwoven fabric layers interleaved with the plurality wound fiber layers; and a resistance measuring circuit electrically coupled with the plurality of metal coated nonwoven fabric layers. The plurality of metal coated nonwoven fabric layers and the resistance measuring circuit can be used to monitor or measure the health of the tank.

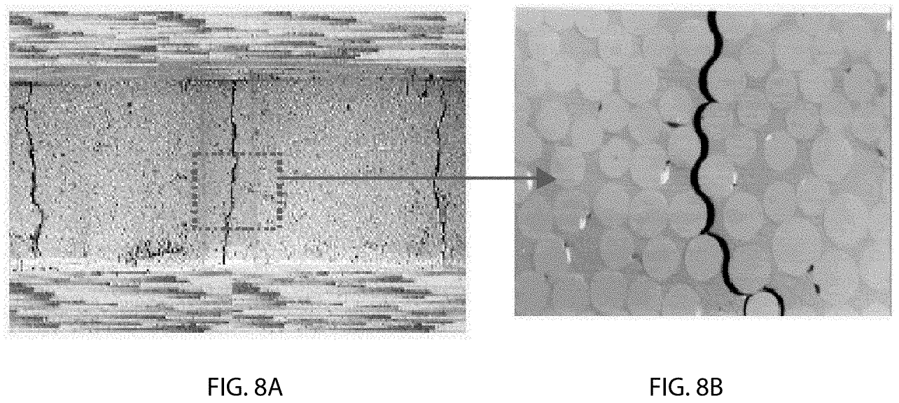

Early detection of damage in the overwrap laminate of a filament wound pressure vessel can be useful to prevent failures. Such damage, for example, may include matrix micro-cracking (see e.g., FIG. 8A and FIG. 8B), delamination, and/or fiber failure. Such damage, for example, may take place as a result of repeated pressurization or thermal cycles, impact, or damage induced from vehicle crashes.

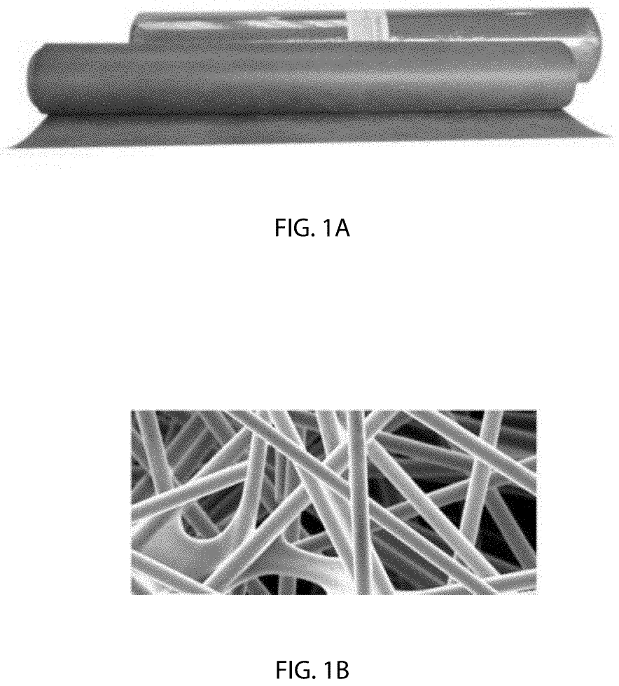

In some embodiments, the sensor layer(s) may include multiple thin-ply conductive composite layers. In some embodiments, these layers may include nonwoven nickel-coated carbon fiber material as shown in FIG. 1A and FIG. 1B.

FIG. 1B shows a microscopic image of a nonwoven metal-coated carbon fiber material. A nonwoven fiber includes a plurality of fibers that are randomly dispersed as shown in FIG. 1B. A nonwoven fiber may have a random orientation of fibers with an open structure between the fibers that may allow for epoxy resin to flow through or infuse the open structure such as, for example, during vacuum bagging or oven-curing. The fibers within a nonwoven metal-coated carbon fiber material, for example, may comprise a nonconductive material such as, for example, comprising carbon, cellulose, cellulose blend, etc. These nonwoven fibers may be coated with a metal (e.g., nickel, copper, gold, silver, bronze, etc.) such as, for example, using chemical vapor deposition.

A nonwoven fiber layer is not a wound fiber layer such as, for example, a filament wound fiber layer.

A woven fiber, on the other hand, may include a plurality of fibers that are organized such as in a pattern or a weave. In addition, a woven fiber may not have an open structure.

In some embodiments, the nonwoven metal-coated carbon fiber material may be thin such as, for example, less than about 0.05, 0.025, 0.01, 0.005, 0.003, 0.001 inches, etc.

In some embodiments, a plurality of layers comprising nonwoven metal-coated carbon fiber material can be layered with other composite layers to produce a health monitoring tank. For example, a plurality of nonwoven metal-coated carbon fiber material layers may be interleaved between other composite layers such as, for example, during a filament winding process.

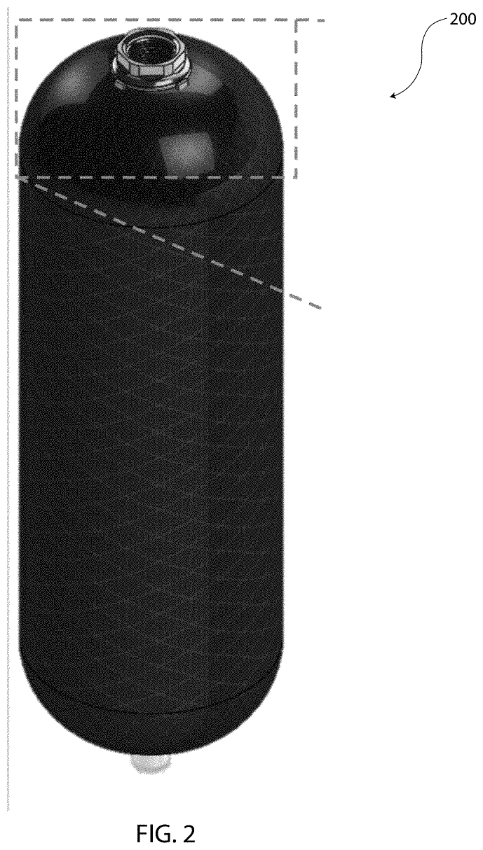

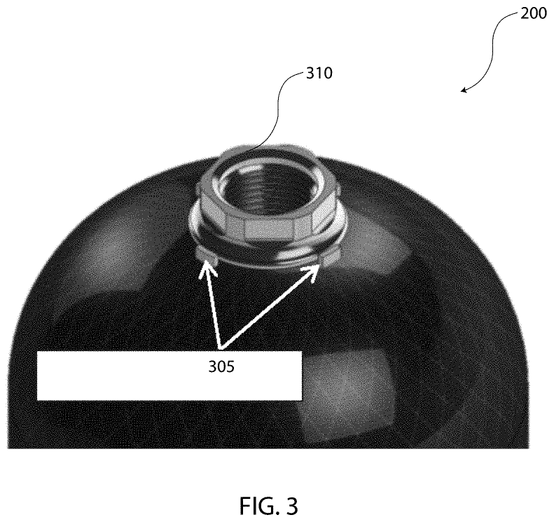

FIG. 2 is an illustration of a health monitoring tank 200 according to some embodiments. FIG. 3 is close up illustration of the top portion of the health monitoring tank 200 according to some embodiments. The health monitoring tank 200 includes an inlet/outlet port 310. The health monitoring tank 200 may also include a plurality of electrodes (or terminals or tabs) 305. Each of the electrodes 305, for example, may be electrically coupled with one of the plurality of nonwoven metal-coated carbon layers within the tank wall.

For example, a health monitoring tank (e.g., health monitoring tank 200) may include two nonwoven coated fabric layers (e.g., sensor layers) coupled with two electrodes. As another example, a health monitoring tank may include four nonwoven coated fabric layers (e.g., sensor layers) coupled with four electrodes. As another example, a health monitoring tank may include multiple nonwoven coated fabric layers (e.g., sensor layers) with each layer coupled with a number of electrodes. In some embodiments, the sensor layers may include a layer comprising a conductive fiber material such as, for example, nickel-fiber material, copper-fiber material, aluminum-fiber material, silver-fiber material, etc. In some embodiments, the sensor layer may include a nonwoven fabric or a woven fabric CVD coated with a metal such as, for example, nickel, copper, gold, silver, bronze, etc.

In some embodiments, the sensor layer may have a thickness less than about 0.05 in such as, for example, less than about 0.01 in. In some embodiments, the sensor layer may have a thickness between 0.01 in and 0.003 in. In some embodiments, the sensor layer may have a thickness less than about 0.005 in such as, for example, less than about 0.003 in.

In some embodiments, a health monitoring tank may include different zones with different sensors. For example, a first layer of the health monitoring tank may have a first sensor in a first zone, a second layer of the health monitoring tank may have a second sensor in a second zone, and/or a third layer of the health monitoring tank may have a third sensor in a third zone, and/or a fourth layer of the health monitoring tank may have a fourth sensor in a fourth zone, etc. Each zone (e.g., first zone, second zone, and/or third zone, and/or fourth zone, etc.) may be located in different portions of the health monitoring tank such as, for example, different lateral portions, different cylindrical portions, different radial portions, etc. Each sensor, for example, may determine when a different portion of the health monitoring tank has a failure. As another example, the different portions of the health monitoring tank may be positioned near failure zones such as, for example, attachment points, contact points, impact points or zones, high stress regions, etc. The electrodes 305 may be disposed anywhere on the health monitoring tank 200. For example, the electrodes 305 may be disposed near the inlet/outlet port 310 of the health monitoring tank 200 as shown in FIG. 3. In some embodiments, the electrodes 305 may be electrically coupled with a connector that is disposed near the inlet/outlet port 310.

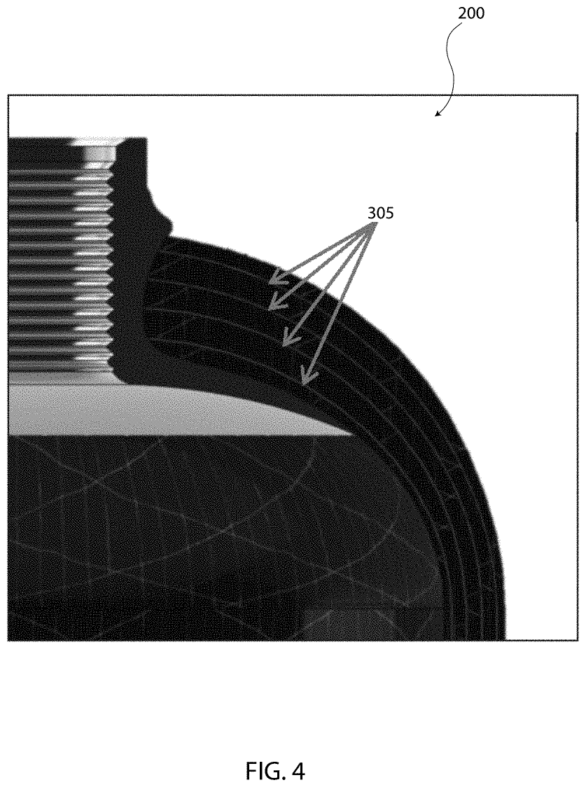

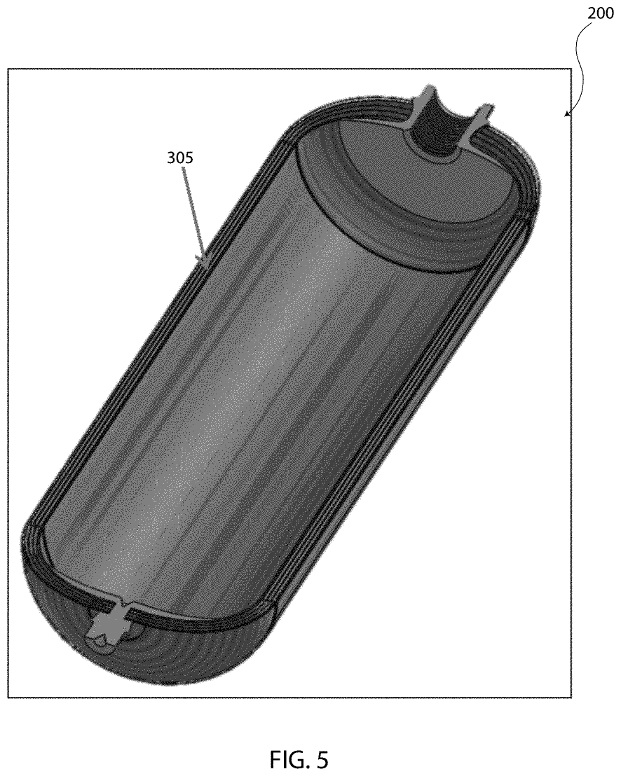

FIG. 4 is a cutaway view of a top portion of a health monitoring tank 200 according to some embodiments. In this example, the health monitoring tank 200 may include four nonwoven metal-coated layers (e.g., sensor layers) 315. FIG. 5 is a transparent section view of a health monitoring tank 200 with four nonwoven metal-coated layers according to some embodiments.

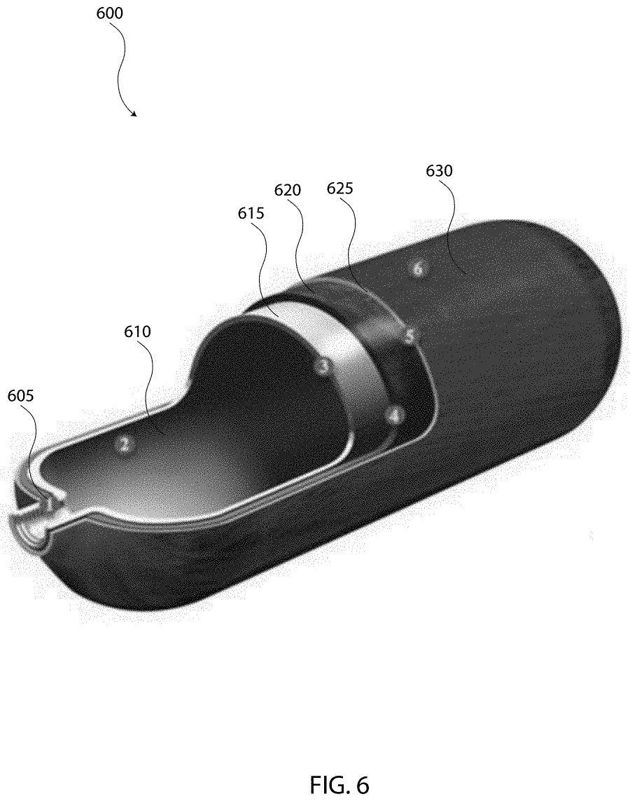

FIG. 6 is an illustration of an aluminum lined self-contained breathing apparatus tank 600 according to some embodiments. The aluminum lined SCBA tank 600 may include a taper 605, internal finish 610, aluminum liner 615 (which could be a polymer layer for other tank types), carbon fiber overwrap in epoxy resin matrix 620, glass fiber overwrap in epoxy resin material 625, and an epoxy gel-coat finish 630. The aluminum liner 615, for example, may include any type of metal or polymer liner depending on the tank type. The layer 620, which may include various types of overwraps or resins may include or be intergraded with one or more sensor layers. Although an SCBA tank is shown, any other type of tank may be included.

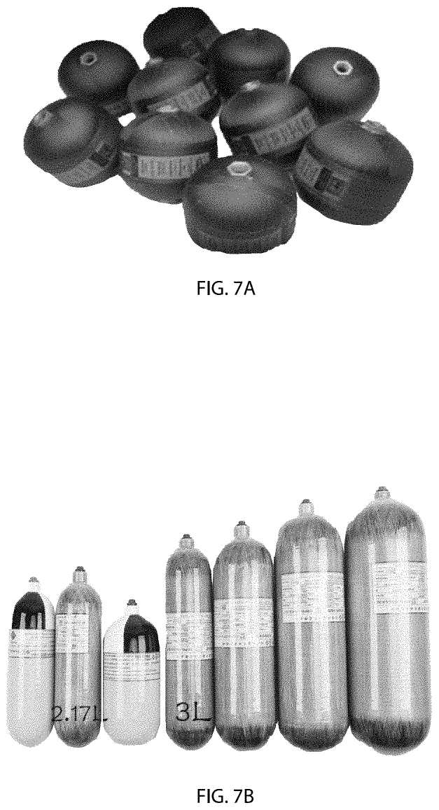

FIG. 7A illustrates examples of composite liner-less tanks according to some embodiments. In some embodiments, a similar composite tank may have a mass of 0.4 Kg and hold a pressure of 1000 psi. FIG. 7B illustrates examples of commercial SCBA tanks according to some embodiments. In some embodiments, a SCBA tank may have a mass of 1.3 Kg and hold a pressure of 3000 psi.

Matrix microcracking within a fiber reinforced composite (e.g., as shown in FIG. 8A and FIG. 8B) can often be the first mode of failure in composite laminates and usually appears as cracks through the matrix without any fiber fracture. Matrix micro-cracking may often be a precursor, an earlier-stage form of damage which may progress to something more significant such as ply failure, or delamination. In some embodiments, the resistance between the sensor layers (e.g., metal coated nonwoven fabric layers) may be monitored or measured. The resistance may be measured or monitored during use of the tank. A change in the resistance, for example, may indicate the existence of a crack or microcrack in the tank.

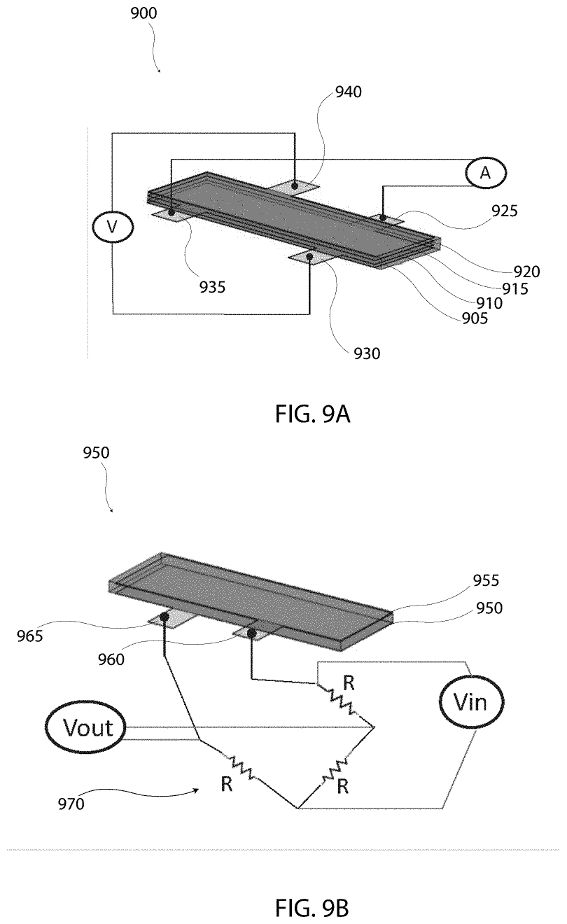

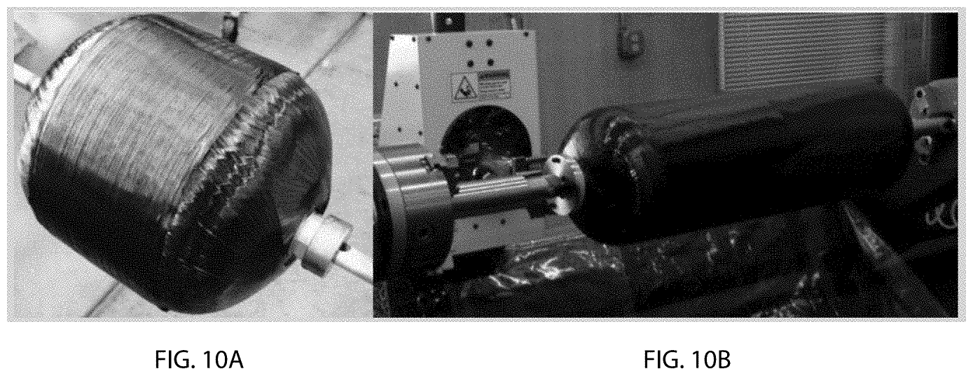

FIG. 9A is a diagram of a four probe health monitoring system 900 for a health monitoring tank according to some embodiments. Four sensor layers (e.g., layer 905, layer 910, layer 915, layer 920) may be disposed within the laminate structure. Each layer, for example, may include an electrode (e.g., electrode 925, electrode 930, electrode 935, electrode 940). In this example, current A can be applied to two layers (e.g., layer 905 and layer 915) through the two electrodes (e.g., electrode 925 and electrode 935) and a voltage V can be measured between the other two layers (e.g., layer 910 and layer 920) through two other electrodes (e.g., electrode 930 and electrode 940) as shown in the figure.

In some embodiments, one or more non-sensor layers (e.g., woven or continuous fiber layers) may be disposed between two sensor layers (e.g., layer 905 and layer 910 or layer 910 and layer 915 or layer 915 and layer 920 or any other sensor layers).

FIG. 9B is a diagram of a two probe health monitoring system 950 according to some embodiments. Two sensor layers (e.g., layer 950 and layer 955) may be disposed within the laminate structure. For example, each layer may include an electrode (e.g., electrode 960 and electrode 965). In this example, a resistance between the two sensor layers (e.g., layer 950 and layer 955) can be measured between the two layers via the two electrodes (e.g., electrode 960 and electrode 965) using a bridge circuit 970 such as, for example, using a Wheatstone circuit by applying a voltage Vin and measuring a voltage Vout. In some embodiments, one or more non-sensor layers (e.g., woven layers) may be disposed between the two sensor layers (e.g., layer 950 and layer 955).

Some embodiments may include a health monitoring tank that includes a plurality of layers (e.g., woven and/or nonwoven layers). One or more of the plurality of layers may include two or more conductive layers that includes a conductive coated fibers such as, for example, nickel, copper, gold, silver, bronze, etc.). The resistance between conductive layers may be measured (e.g., as shown in FIG. 9A or 9B).

If a crack or microcrack occurs in layers between sensor layers, the conductive path between the sensor layers may be decreased, which may, in turn, increase the resistance between the sensor layers. Thus, the health of the tank may be monitored and/or determined by measuring increases in the resistance between sensor layers.

Compared to other health monitoring technologies or schemes, embodiments described in this document are relatively simple and can be integrated and managed by a controller. The controller may include a computer systems such as, for example, vehicle computer systems. In some embodiments, each time a vehicle is turned on or prior to turning it on, a rapid resistance measurement can be taken of a tank wall. The single value measurement may be recorded, trended, or compared to acceptable levels in order to trigger vehicle warning indicators, or prevent operation of the vehicle as necessary.

In some embodiments, the controller may actively monitor the health monitoring tank such as, for example, in real time. In response to a change in resistance, for example, the controller may provide an indication to a user through a user interface. For example, if the change in resistance is of a given magnitude the indication may indicate that the health monitoring tank needs maintenance, should be replaced, the user should stop operating a vehicle, send an indication to a maintenance team, etc.

In some embodiments, the controller may control the input voltage and/or input current into the sensor layers, measure the output voltage between sensor layers, filter the measured voltage, monitor the voltage, determine whether voltage decreases are above a thresholds, provide warnings, etc.

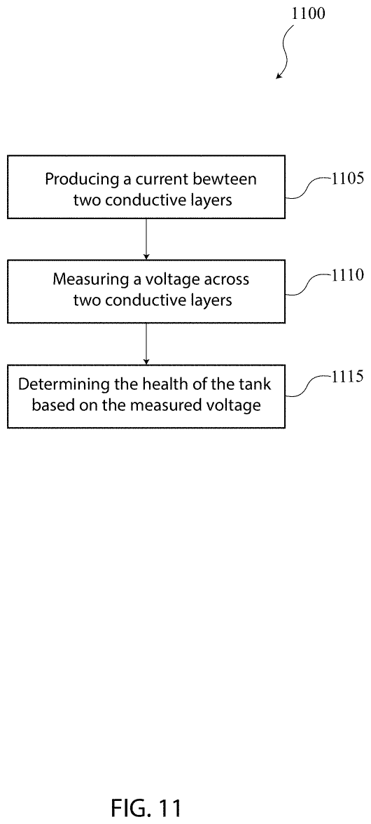

FIG. 11 is a flowchart of a process 1100 for monitoring the health of the tank according to some embodiments. The blocks of process 1100 may be performed in any order and some blocks may be removed and others added.

The process 1100 starts at block 1105 where a current is produced between two conductive layers of a tank. One or more non-conductive layers may be disposed between the two conductive layers. The current may be produced by placing a voltage between the two conductive lawyers.

At block 1110, a voltage may be measured across two conductive layers. The voltage, for example, may be measured across the same two conductive layers that had the current produced between the layers (see FIG. 9B). As another example, the voltage may be measured across two different conductive layers that those that had current produced between the layers (see FIG. 9A).

At block 1115, the health of the tank may be determined based on the measured voltage. For example, the resistance may be calculated from ohms law based on the produced current and the measured voltage. The health of the tank can be determined, for example, based on a comparison of the resistance with a various predetermined resistance values. In some embodiments, the measured voltage may be filtered and/or averaged.

As another example, the health of the tank can be determined based on the amount of change between resistance values. If the change in resistance is greater than a predetermined value or a percentage, then there may be a crack in the tank.

As another example, the health of the tank can be determined based the derivative of the resistance values over time. (e.g., the slope). If the time rate of change in resistance for a period of time is greater than a predetermined value or a percentage, than there may be a crack in the tank.

In some embodiments, a message or alert may be sent based on the health of the tank. For example, if the tank is found to be at moderate risk, then an alert to have the tank more thoroughly tested may be sent. As another example, if the tank is found to be at high risk, then an alert to avoid using the tank or abandon the vehicle may be sent.

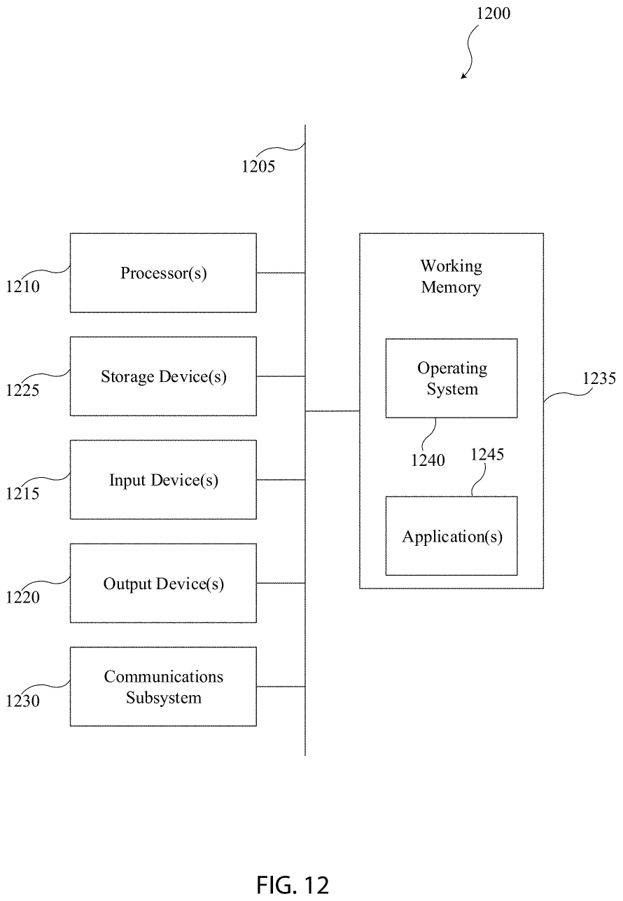

The computational system 1200, shown in FIG. 12 can be used to perform any of the embodiments of the invention and or may embody a controller as described above. For example, computational system 1200 can be used to execute method 1100. As another example, computational system 1200 can be used perform any calculation, identification and/or determination described here. Computational system 1200 includes hardware elements that can be electrically coupled via a bus 1205 (or may otherwise be in communication, as appropriate). The hardware elements can include one or more processors 1210, including without limitation one or more general-purpose processors and/or one or more special-purpose processors (such as digital signal processing chips, graphics acceleration chips, and/or the like); one or more input devices 1215, which can include without limitation a mouse, a keyboard and/or the like; and one or more output devices 1220, which can include without limitation a display device, a printer and/or the like.

The computational system 1200 may further include (and/or be in communication with) one or more storage devices 1225, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1200 might also include a communications subsystem 1230, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 1230 may permit data to be exchanged with a network (such as the network described below, to name one example), and/or any other devices described herein. In many embodiments, the computational system 1200 will further include a working memory 1235, which can include a RAM or ROM device, as described above.

The computational system 1200 also can include software elements, shown as being currently located within the working memory 1235, including an operating system 1240 and/or other code, such as one or more application programs 1245, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1225 described above.

In some cases, the storage medium might be incorporated within the computational system 1200 or in communication with the computational system 1200. In other embodiments, the storage medium might be separate from a computational system 1200 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1200 and/or might take the form of source and/or installable code, which, upon compilation and/or installation on the computational system 1200 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A health monitoring tank comprising:
a plurality of wound fiber layers;
a plurality of conductor coated layers interleaved between two or more of the plurality wound fiber layers; and
a resistance measuring circuit coupled with the plurality of conductor coated carbon fabric layers.

2. The health monitoring tank according to claim 1, wherein the plurality of conductor coated layers comprise nonwoven fabric layers.

3. The health monitoring tank according to claim 1, wherein the conductor coated nonwoven fabric layers comprise copper coated nonwoven fabric layers.

4. The health monitoring tank according to claim 1, wherein the conductor comprises nickel, copper, gold, silver, and bronze.

5. The health monitoring tank according to claim 1, wherein the conductor coated nonwoven fabric layers comprise conductor coated nonwoven carbon fabric layers.

6. The health monitoring tank according to claim 1, further comprising a plurality of electrodes coupled with a respective one of the plurality of conductor coated nonwoven fabric layers.

7. The health monitoring tank according to claim 1, further comprising an epoxy resin disposed with the plurality of wound fiber layers and the plurality of conductor coated nonwoven carbon fabric layers.

8. The health monitoring tank according to claim 1, further comprising a controller coupled with the resistance measuring circuit that determines a change in resistance between at least two of the plurality of conductor coated nonwoven fabric layers.

9. A health monitoring tank comprising:
a plurality of wound fiber layers;
a plurality of metal coated conductive layers interleaved with the plurality wound fiber layers; and
a resistance measuring circuit coupled with the plurality of metal coated nonwoven carbon fabric layers.

10. The health monitoring tank according to claim 9, further comprising a plurality of electrodes coupled with a respective one of the plurality of metal coated nonwoven fabric layers.

11. The health monitoring tank according to claim 9, wherein the metal comprises nickel.

12. The health monitoring tank according to claim 9, wherein the nonwoven fabric layers comprise carbon.

13. The health monitoring tank according to claim 9, further comprising an epoxy resin disposed with the plurality of wound fiber layers and the plurality of metal coated nonwoven fabric layers.

14. A method comprising:
providing a current between two conductive layers of a tank, wherein one or more non-conductive layers are disposed between the two conductive layers;
measuring a voltage across the two conductive layers; and
determining the health of the tank based on the measured voltage.

15. The method according to claim 14, further comprising determining whether the voltage across the two conductive layers is greater than a predetermined threshold.

16. The method according to claim 14, further comprising providing a warning message via a communication interface.

17. The method according to claim 14, wherein the two conductive layers are nonwoven and the one or more non-conductive layers are woven.

18. A method comprising:
providing a voltage between a first conductive layer and a second conductive layer of a tank, wherein one or more non-conductive layers are disposed between the first conductive layer and the second conductive layer;
measuring a voltage between a third conductive layer and a fourth conductive layer of a tank, wherein one or more non-conductive layers are disposed between the third conductive layer and the fourth conductive layer; and
determining the health of the tank based on the measured voltage.

19. The method according to claim 18, further comprising determining whether the voltage across the two conductive layers is greater than a predetermined threshold.

20. The method according to claim 18, further comprising providing a warning message via a communication interface.

21. The method according to claim 18, wherein the first conductive layer, the second conductive layer, the third conductive layer, and the fourth conductive layer are nonwoven and the one or more non-conductive layers are woven.
